(19) United States
(12) Patent Application Publication
(10) Pub. No.: US 2005/0229033 A1
(43) Pub. Date: Oct. 13, 2005

(54) Disk array controller and information processing apparatus

(75) Inventors: Kazuyuki Tanaka, Tachikawa-shi (JP); Takehiko Kurashige, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/087,635

(22) Filed: Mar. 24, 2005

(30) Foreign Application Priority Data
Apr. 1, 2004 (JP) 2004-109172

(51) Int. Cl. G06F 11/00

(52) U.S. Cl. 714/6

(57) ABSTRACT

A disk array controller has a function of relocating a plurality of data blocks stored in a disk array. The controller includes a read unit which reads data blocks to be relocated from the disk array, a determining unit which determines whether an error has occurred in the to-be-relocated data block read by the read unit, a write unit which writes the to-be-relocated data block read by the read unit in a relocating destination position on the disk array which corresponds to the to-be-relocated data block if the determining unit determines that the error has not occurred in the to-be-relocated data block, and a unit which sets error information with respect to the relocating destination position if the determining unit determines that the error has occurred in the to-be-relocated data block, the error information causing occurrence of an error in response to read access of the relocating destination position.

### CROSS-REFERENCE TO RELATED APPLICATIONS

This application is based upon and claims the benefit of priority from prior Japanese Patent Application No. 2004-109172, filed Apr. 1, 2004, the entire contents of which are incorporated herein by reference.

### BACKGROUND OF THE INVENTION

1. Field of the Invention

This invention relates to a disk array controller and information processing apparatus which control a redundant disk array such as a RAID (Redundant Array of Inexpensive Disks or Redundant Array of Independent Disks).

2. Description of the Related Art

Recently, in an information processing apparatus such as a server computer and personal computer, a redundant disk array such as RAID has been utilized in order to enhance the disk access speed and protect stored data. In the RAID, some redundancy levels (which are also referred to as RAID levels), for example, RAID0, RAID1, RAID5 are defined.

Most of the RAID controllers have a rebuild function of restoring the state of a disk array in which a fault has occurred into the state set before occurrence of the fault. The rebuild function is a function of restoring the contents of data stored in a disk drive in which a fault has occurred by use of the contents of data stored in another disk drive.

A disk control apparatus having the rebuilt function is disclosed in Jpn. Pat. Appln. KOKAI Publication No. 10-40022.

Further, in the recent RAID controller, it is required to attain not only a function such as a rebuild function of taking measures to prevent occurrence of faults but also a function of changing the redundancy level (RAID level) of the disk array or expanding the storage capacity.

In order to perform the level changing process of changing the redundancy level (RAID level) of the disk array or the capacity expanding process of expanding the storage capacity of the disk array, it is necessary to relocate a data block group stored in the disk array.

However, if a media error occurs in the storage position on the disk array in which one of the data blocks to be relocated is stored, the level changing process or capacity expanding process cannot be performed. In this case, the media error represents an error which prevents data from being correctly read from the disk drive even if read tries are repeatedly made by a preset number of times.

Since the to-be-relocated data block cannot be read from the storage position in which the above error occurs, it becomes impossible to ensure the contents of data in a transfer-destination position to which the to-be-relocated data block is transferred. Therefore, in the level changing process or capacity expanding process, if occurrence of an error is detected at the time of reading the to-be-relocated data block, it is necessary to interrupt the process at this time point. If the process is not interrupted, there occurs a possibility that data of an erroneous value may be transferred from the disk array to a host when a read request is issued by the host with respect to the transfer-destination position to which the data block could not be transferred after the level changing process or capacity expanding process.

### BRIEF SUMMARY OF THE INVENTION

According to an aspect of the invention, there is provided a disk array controller which controls a disk array to change a redundancy level of the disk array, comprising a read unit which reads a data block to be relocated from the disk array, a determining unit which determines whether or not an error has occurred in the to-be-relocated data block read by the read unit, a write unit which writes the to-be-relocated data block read by the read unit in a relocating destination position on the disk array corresponding to the to-be-relocated data block if the determining unit determines that the error has not occurred in the to-be-relocated data block, and an error information setting unit configured to set error information with respect to the relocating destination position if the determining unit determines that the error has occurred in the to-be-relocated data block, the error information causing occurrence of an error in response to read access of the relocating destination position.

According to another aspect of the invention, there is provided a disk array controller which controls a disk array to expand storage capacity of the disk array, comprising a read unit which reads a data block to be relocated from the disk array, a determining unit which determines whether or not an error has occurred in the to-be-relocated data block read out by the read unit, a write unit which writes the to-be-relocated data block read by the read unit in a relocating destination position on the disk array corresponding to the to-be-relocated data block if the determining unit determines that the error has not occurred in the to-be-relocated data block, and an error information setting unit configured to set error information with respect to the relocating destination position if the determining unit determines that the error has occurred in the to-be-relocated data block, the error information causing occurrence of an error in response to read access of the relocating destination position.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing the configuration of an information processing apparatus according to a first embodiment of this invention;

FIG. 2 is a diagram showing a first example of the configuration of a disk array obtained before changing the redundancy level and used in the information processing apparatus of FIG. 1;

FIG. 3 is a diagram showing a first example of the configuration of a disk array obtained after changing the redundancy level and used in the information processing apparatus of FIG. 1;

FIG. 4 is a diagram showing a second example of the configuration of a disk array obtained before changing the redundancy level and used in the information processing apparatus of FIG. 1;

FIG. 5 is a diagram showing a second example of the configuration of a disk array obtained after changing the redundancy level and used in the information processing apparatus of FIG. 1;

FIG. 6 is a block diagram showing an example of the configuration of a redundancy level changing unit used in the information processing apparatus of FIG. 1;

FIG. 7 is a first flowchart for illustrating the procedure of a redundancy level changing process performed in the information processing apparatus of FIG. 1;

FIG. 8 is a second flowchart for illustrating the procedure of a redundancy level changing process performed in the information processing apparatus of FIG. 1;

FIG. 9 is a flowchart for illustrating the procedure of a data read operation performed in the information processing apparatus of FIG. 1;

FIG. 10 is a diagram showing a first example of the configuration of a disk array obtained before expanding the storage capacity and used in the information processing apparatus of FIG. 1;

FIG. 11 is a diagram showing a first example of the configuration of a disk array obtained after expanding the storage capacity and used in the information processing apparatus of FIG. 1;

FIG. 12 is a diagram showing a second example of the configuration of a disk array obtained before expanding the storage capacity and used in the information processing apparatus of FIG. 1;

FIG. 13 is a diagram showing a second example of the configuration of a disk array obtained after expanding the storage capacity and used in the information processing apparatus of FIG. 1;

FIG. 14 is a block diagram showing an example of the configuration of a capacity expanding unit used in the information processing apparatus of FIG. 1;

FIG. 15 is a flowchart for illustrating the procedure of a capacity expanding process performed in the information processing apparatus of FIG. 1;

FIG. 16 is a block diagram showing the configuration of an information processing apparatus according to a second embodiment of this invention;

FIG. 17 is a block diagram showing the relationship between a redundancy level changing unit, media error detecting unit and error address recording unit used in the information processing apparatus of FIG. 16;

FIG. 18 is a flowchart for illustrating the procedure of a redundancy level changing process performed in the information processing apparatus of FIG. 16;

FIG. 19 is a block diagram showing the relationship between a capacity expanding unit, media error detecting unit and error address recording unit used in the information processing apparatus of FIG. 16;

FIG. 20 is a flowchart for illustrating the procedure of a capacity expanding process performed in the information processing apparatus of FIG. 16; and

FIG. 21 is a flowchart for illustrating the procedure of a data reading process performed in the information processing apparatus of FIG. 16.

### DETAILED DESCRIPTION OF THE INVENTION

There will now be described embodiments of this invention with reference to the accompanying drawings.

### First Embodiment

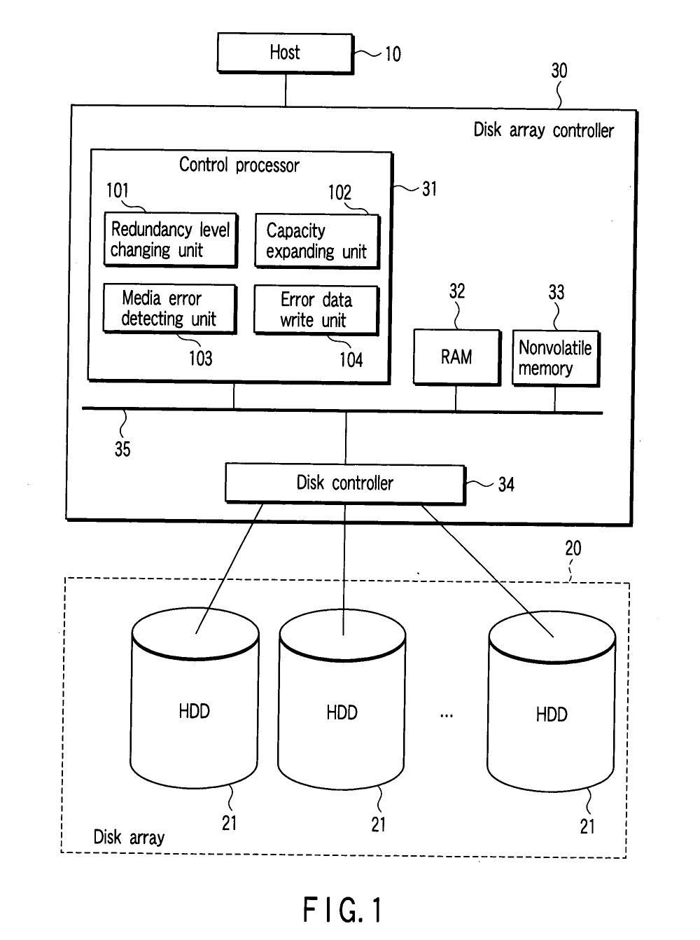

In FIG. 1, the configuration of an information processing apparatus according to a first embodiment of this invention is shown. For example, the information processing apparatus is realized as a server computer. The information processing apparatus includes a host (host computer) 10 which executes an operating system and various application programs, a disk array 20 used as an external storage device of the host 10, and a disk array controller 30.

The disk array 20 is a redundant disk array and is realized by use of a plurality of disk drives (hard disk drives [HDDs]) 21 mounted on the information processing apparatus. The disk array controller 30 controls the disk array 20 in response to a disk access request from the host 10. The disk array controller 30 performs the disk control operation to operate the disk array 20 as a RAID.

For example, the disk array controller 30 supports a plurality of redundancy levels (RAID levels) such as RAID0 (striping), RAID1 (mirroring) and RAID5 (distributed data guarding).

As shown in FIG. 1, the disk array controller 30 includes a control processor 31, RAM 32, nonvolatile memory 33 and disk controller 34. The control processor 31, RAM 32, nonvolatile memory 33 and disk controller 34 are connected to a bus 35.

The control processor 31 executes a program (firmware) loaded from the nonvolatile memory 33 into the RAM 32. By use of the firmware, in the control processor 31, a redundancy level changing unit 101, capacity expanding unit 102, media error detecting unit 103 and error data write unit 104 are realized as shown in FIG. 1 as function performing modules.

The redundancy level changing unit 101 performs a redundancy level changing process to change the redundancy level (RAID level) of the disk array 20. The redundancy level changing process can be performed during the operation of the information processing apparatus. In the redundancy level changing process, a process of relocating a plurality of data blocks stored in the disk array 20 is performed based on the relationship between the present redundancy level of the disk array 20 and the target redundancy level of the disk array 20. The relocation process is performed by reading each data block to be relocated from the disk array 20 and copying and supplying the same to a relocating destination position on the disk array 20 to which each data block should be relocated. By the level changing process, the RAID level of the disk array 20 can be changed from RAID0 to RAID1 or from RAID0 to RAID5, for example.

The capacity expanding unit 102 performs a capacity expanding process of expanding the storage capacity of the disk array 20 by use of an additional disk drive without changing the redundancy level of the disk array 20. The capacity expanding process can also be performed during the operation of the information processing apparatus. In the capacity expanding process, a process of relocating a plurality of data blocks which is already stored in the disk array 20 on an additional disk drive for each stripe unit is performed based on the present redundancy level of the disk array 20 and the number of additional disk drives. The relocation process is performed by reading each data block to be relocated from the disk array 20 and copying and supplying the same to a relocating destination position on the disk array 20 to which each data block should be relocated.

The media error detecting unit 103 determines whether or not a media error has occurred at the read time of a to-be-relocated data block. The error data write unit 104 sets error information with respect to the relocating destination position (which is herein-after referred to as a transfer destination position) corresponding to the to-be-relocated data block when occurrence of a media error is detected. The error information is information (error data) which causes occurrence of a media error when read access is made with respect to the transfer destination position. More specifically, the error data write unit 104 writes data and an error-correcting code (ECC) which is not associated with the data as error data in the transfer destination position. Thus, each time the read access is made to the transfer destination position, a media error occurs. Therefore, even if read access is made by the host 10 to the transfer destination position which could not be correctly subjected to a data relocation process, erroneous data can be prevented from being transferred to the host 10.

The error data write unit 104 issues a write long command to the HDD in order to write error data. The write long command is a command which instructs the HDD to store write data containing the error-correcting code as it is. Generally, the HDD causes an ECC generator to generate an ECC based on write data and writes the write data and ECC into a position specified by the write command. Further, when the write command is received, the operation of the ECC generator of the HDD is suppressed. Thus, error data containing data and an ECC which is not associated with the data can be written.

The disk controller 34 controls each of the HDDs configuring the disk array 20 under the control of the control processor 31. The disk controller 34 controls each HDD via an Integrated Drive Electronics (IDE) or Small Computer System Interface (SCSI) interface, for example.

Next, an example of the redundancy level changing operation is explained.

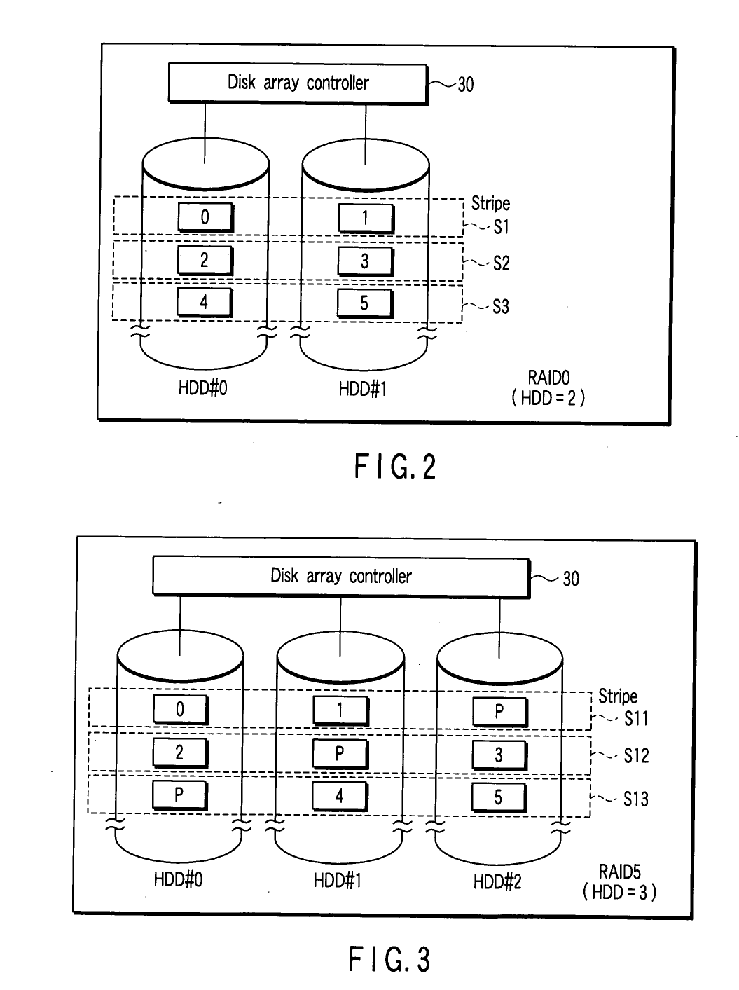

FIG. 2 shows a disk array of RAID0 configured by two HDDs (HDD#0, HDD#1). A plurality of stripes S1, S2, S3 are arranged over the two HDDs (HDD#0, HDD#1).

Each stripe is configured by a stripe unit on the HDD#0 and a stripe unit on the HDD#1. Each stripe unit contains at least one data block. In FIG. 2, a case wherein the number of data blocks contained in each stripe unit is one is shown. The stripe S1 contains a data block of logical block address LBA=“0” arranged on the HDD#0 and a data block of logical block address LBA=“1” arranged on the HDD#1. Likewise, the stripe S2 contains a data block of logical block address LBA=“2” arranged on the HDD#0 and a data block of logical block address LBA=“3” arranged on the HDD#1. Further, the stripe S3 contains a data block of logical block address LBA=“4” arranged on the HDD#0 and a data block of logical block address LBA=“5” arranged on the HDD#1.

The stripe is referred to as a stripe group and the stripe unit is referred to as a stripe in some cases.

FIG. 3 shows an example in which one HDD (HDD#2) is additionally provided on the disk array of RAID0 shown in FIG. 2 and the disk array of RAID5 is configured by three HDDs (HDD#0, HDD#1, HDD#2).

The RAID level of the disk array 20 can be changed from RAID0 to RAID5 by relocating data block groups corresponding to logical block addresses LBA0 to LBA5 stored in the disk array of FIG. 2 on the three HDDs (HDD#0, HDD#1, HDD#2) as shown in FIG. 3.

In FIG. 3, a symbol P indicates information (parity) used to restore a faulty portion which has occurred. The stripe S11 contains a data block of logical block address LBA=“0” arranged on the HDD#0, a data block of logical block address LBA=“1” arranged on the HDD#1 and a parity P arranged on the HDD#2. The parity P of the stripe S11 is generated based on the two data blocks (LBA=“0”, LBA=“1”) of the stripe S11. The stripe S12 contains a data block of logical block address LBA=“2” arranged on the HDD#0, a parity P arranged on the HDD#1 and a data block of logical block address LBA=“3” arranged on the HDD#2. The parity P of the stripe S12 is generated based on the two data blocks (LBA=“2”, LBA=“3”) of the stripe S12. Further, the stripe S13 contains a parity P arranged on the HDD#0, a data block of logical block address LBA=“4” arranged on the HDD#1 and a data block of logical block address LBA=“5” arranged on the HDD#2. The parity P of the stripe S13 is generated based on the two data blocks (LBA=“4”, LBA=“5”) of the stripe S13.

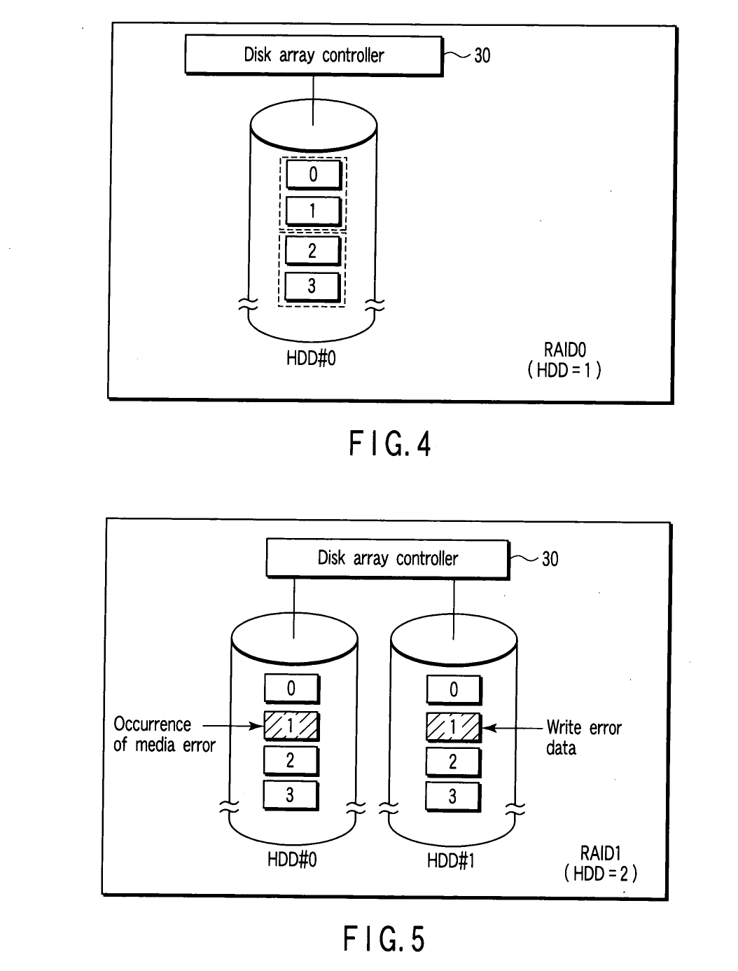

RAID0 can be configured in principle on one HDD as shown in FIG. 4. In FIG. 4, each stripe unit is configured by two data blocks whose logical block addresses are successive.

FIG. 5 shows an example in which one HDD (HDD#1) is additionally provided on the disk array of RAID0 shown in FIG. 4 and the disk array of RAID1 is configured by two HDDs (HDD#0, HDD#1).

The RAID level can be changed from RAID0 to RAID1 by copying and relocating data block groups corresponding to logical block addresses LBA0 to LBA3 stored in the HDD#0 of FIG. 4 on the HDD#2 as shown in FIG. 5.

Thus, in the redundancy level changing process, the data relocation process is performed for each of the data blocks.

If a media error does not occur at the read time of the data block to be relocated, the to-be-relocated data block is written into the transfer destination position as usual. The transfer destination position is a storage position on the disk array to which a logical block address corresponding to the to-be-relocated data block is newly allocated. Further, if a media error occurs at the read time of the to-be-relocated data block, the error data is written into the transfer destination position.

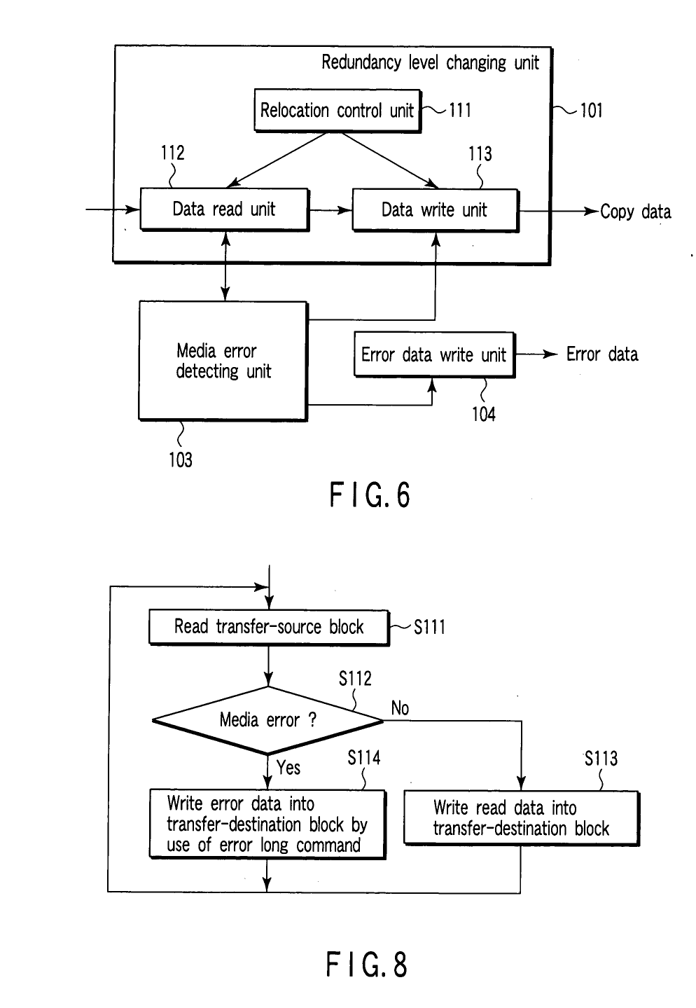

FIG. 6 shows an example of the configuration of the redundancy level changing unit 101.

The redundancy level changing unit 101 includes a relocation control unit 111, data read unit 112 and data write unit 113. The relocation control unit 111 determines data block groups to be relocated and the transfer destination positions of the to-be-relocated data block groups based on the relation between the present redundancy level of the disk array 20 and the target redundancy level of the disk array 20. The data read unit 112 reads a to-be-relocated data block from the disk array 20 via the disk controller 34 under the control of the relocation control unit 111. The data write unit 113 writes the to-be-relocated data block read by the data read unit 112 in the transfer destination position on the disk array 20 via the disk controller 34 under the control of the relocation control unit 111.

The media error detecting unit 103 detects occurrence of a media error by monitoring success/failure of the read operation via communication with the data read unit 112. If occurrence of a media error is detected, the media error detecting unit 103 inhibits the operation of the data write unit 113 and triggers the error data write unit 104.

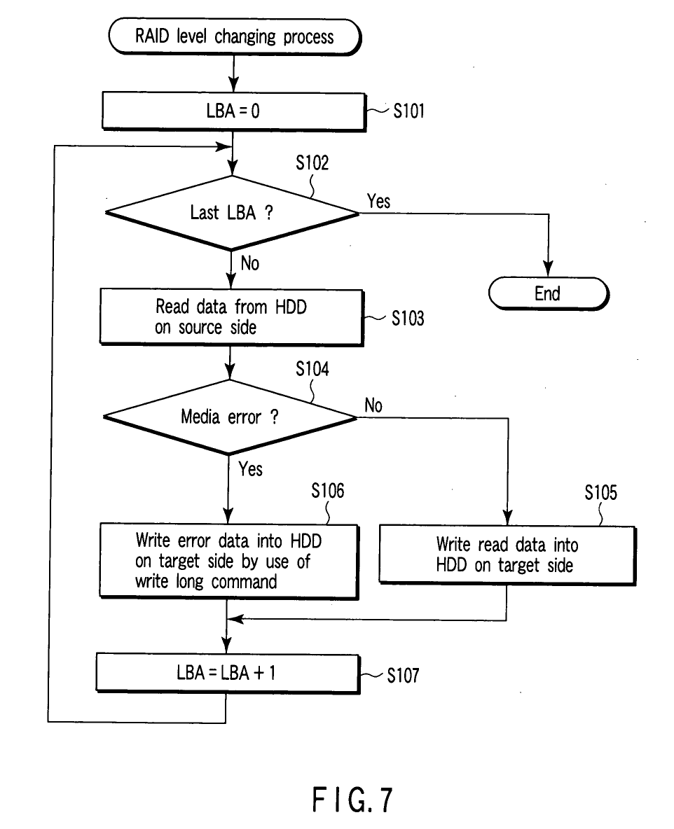

Next, the concrete procedure of the redundancy level (RAID level) changing process is explained with reference to the flowchart of FIG. 7. In this case, a case wherein the redundancy level is changed from RAID0 of FIG. 4 to RAID1 of FIG. 5 is explained as an example.

First, the redundancy level changing unit 101 sets a value of the logical block address LBA to an initial value “0” (step S101). Then, the redundancy level changing unit 101 determines whether or not the value of the logical block address LBA exceeds a last logical block address LBA (Last LBA) allocated to the HDD#0 of FIG. 4 (step S102) and repeatedly performs the following process until the value of the logical block address LBA exceeds the last logical block address LBA.

The redundancy level changing unit 101 reads a to-be-relocated data block specified by the present logical block address LBA (LBA=0) from the HDD#0 (source side HDD) (step S103). The media error detecting unit 103 determines whether or not a media error has occurred in the read operation (step S104).

If occurrence of a media error is not detected, that is, if a to-be-relocated data block specified by the present logical block address LBA (LBA=0) can be correctly read from the HDD#0 (source side HDD) (“NO” in step S104), the redundancy level changing unit 101 writes the to-be-relocated data block read out in step S103 into a transfer destination position on the HDD#1 (target side HDD) corresponding to the to-be-relocated data block (step S105). The transfer destination position is a storage position on the HDD#1 (target side HDD) to which the logical block address LBA (LBA=0) is allocated. Thus, the data block of the source side HDD specified by the present LBA is copied in the storage position on the target side HDD specified by the above LBA.

On the other hand, if occurrence of a media error is detected, that is, if a to-be-relocated data block specified by the present logical block address LBA (LBA=0) cannot be correctly read from the HDD#0 (source side HDD) (“YES” in step S104), the redundancy level changing unit 101 writes error data by use of a write long command in a transfer destination position on the HDD#1 (target side HDD) corresponding to the to-be-relocated data block which cannot be read, that is, in a storage position on the target side HDD specified by the present LBA (LBA=0) (step S106).

Next, the redundancy level changing unit 101 returns the process to step S102 after the present logical block address LBA is increased by +1 (step S107). The RAID level of the disk array 20 is changed from RAID0 to RAID1 by repeatedly performing the process of steps S102 to S107.

In this case, all of the data blocks are dealt with as to-be-relocated data blocks in order to make a level change from RAID0 to RAID1. However, generally, it is only necessary to relocate only a target data block group which is required to be relocated in order to make a level change. That is, the redundancy level changing unit 101 determines logical block addresses of data blocks (transfer-source blocks) to be relocated and transfer destination positions (transfer destination blocks) corresponding to the logical block addresses based on the number of HDDs and RAID levels of the disk array 20 before level-changing and the number of HDDs and RAID levels of the disk array 20 after level-changing which are specified by the host 10. Then, the redundancy level changing unit 101 performs the process shown by the flowchart of FIG. 8 for each transfer-source block.

That is, the redundancy level changing unit 101 first reads a transfer-source block from the disk array 20 (step S111). If a media error does not occur in the read operation (“NO” in step S112), the redundancy level changing unit 101 writes the readout transfer-source block into a transfer-destination block corresponding to the transfer-source block (step S113). On the other hand, if a media error occurs in the read operation (“YES” in step S112), the error data write unit 104 writes error data in the transfer-destination block (step S114).

The transfer-source block in which a media error has occurred in the read operation may be used as a transfer-destination block for a different to-be-relocated data block in some cases. In this case, if the different to-be-relocated data block cannot be correctly written into the transfer-destination block, error data is also written into the transfer-destination block.

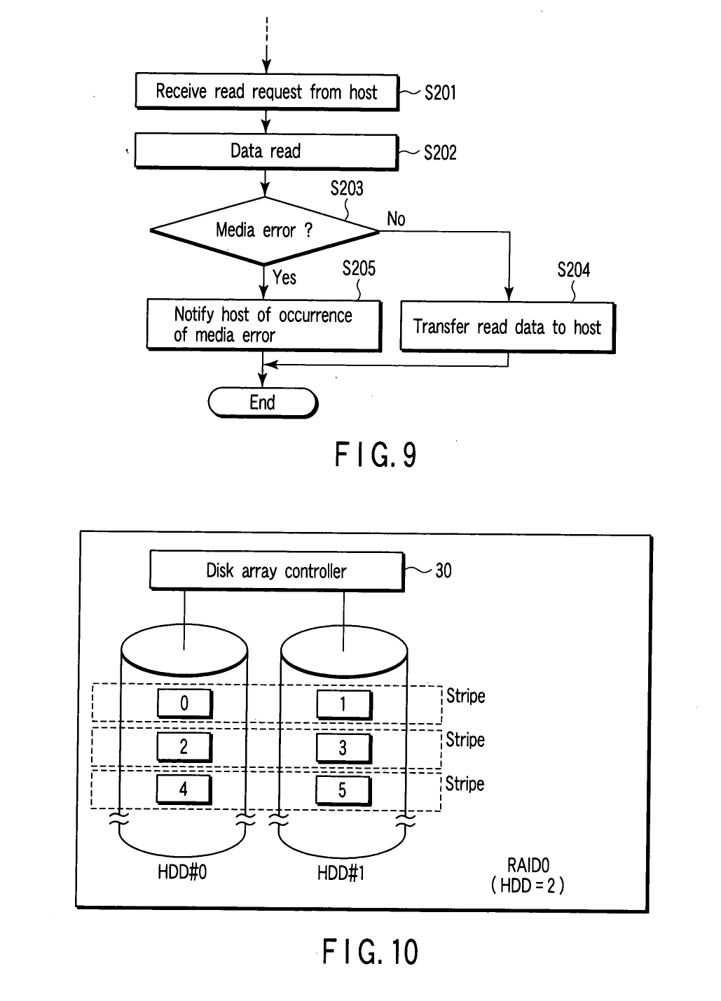

Next, the operation for reading data from the disk array 20 whose RAID level is changed is explained with reference to the flowchart of FIG. 9.

When the control processor 31 receives a read request from a file system or application program executed by the host 10 (step S201), it reads a data block specified by the logical block address contained in the read request from the disk array 20 (step S202). The control processor 31 determines whether or not a media error has occurred in the read operation of step S202 (step S203). If a media error does not occur (“NO” in step S203), the control processor 31 transfers a data block read from the disk array 20 to the host 10 (step S204). If a media error has occurred (“YES” in step S203), the control processor 31 notifies the host 10 of occurrence of the media error (step S205). Since a media error occurs without fail when a read request is made from the host 10 with respect to a block in which error data is written, erroneous data can be prevented from being transferred to the host 10.

Next, an example of the capacity expanding operation is explained.

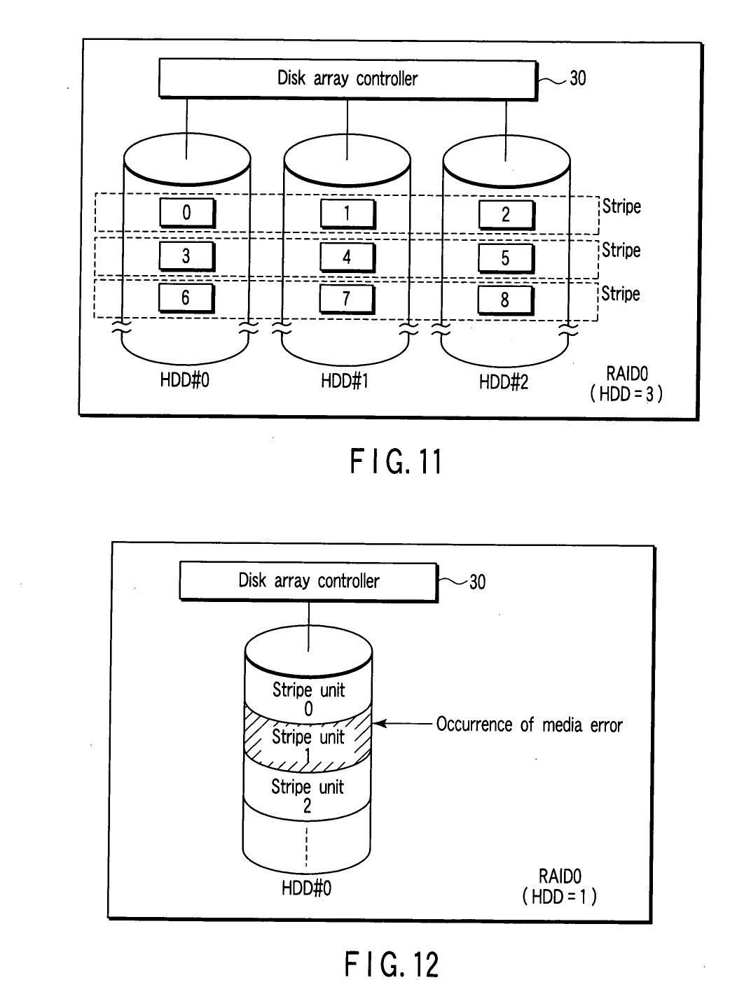

FIG. 10 shows a disk array of RAID0 configured by two HDDs (HDD#0, HDD#1). In FIG. 10, a case wherein the number of data blocks contained in each stripe unit is one is shown. FIG. 11 shows an example in which one HDD (HDD#2) is additionally provided to the disk array of RAID0 of FIG. 10 to configure the disk array of RAID0 by three HDDs (HDD#0, HDD#1, HDD#2). The storage capacity of the disk array can be expanded without changing the RAID level by relocating the data block groups corresponding to the logical block addresses LBA0 to LBA5 stored in the disk array of FIG. 10 into the three HDDs (HDD#0, HDD#1, HDD#2) as shown in FIG. 11 for each stripe unit.

FIG. 12 shows a disk array of RAID0 configured on one HDD (HDD#0). Each stripe unit normally contains two or more data blocks whose logical block addresses are successive.

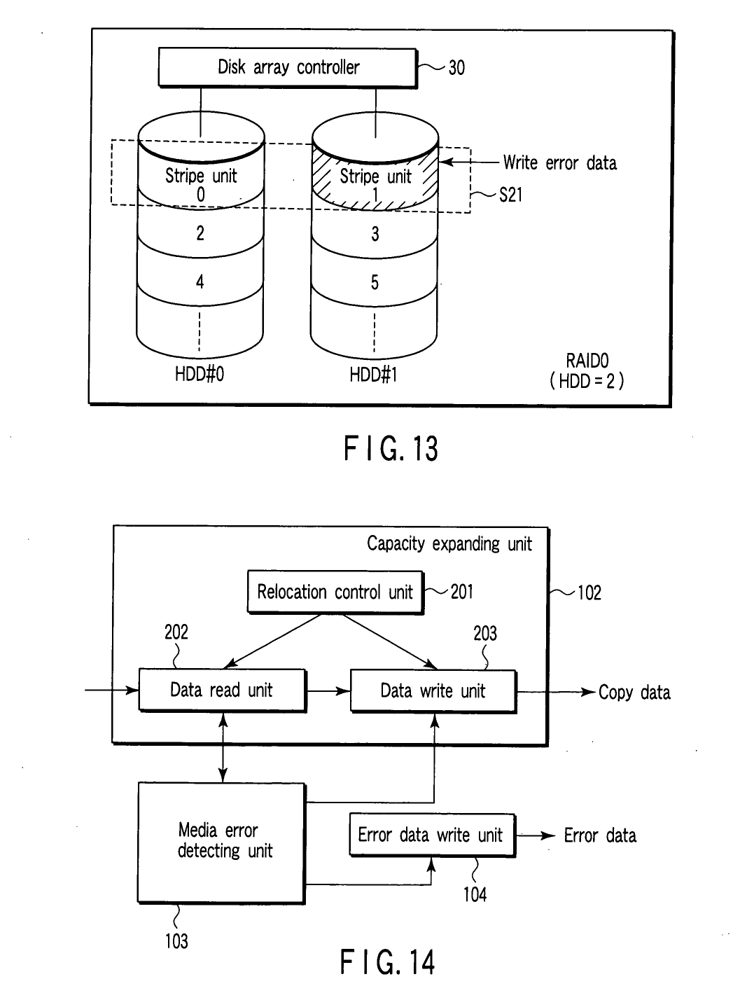

FIG. 13 shows an example in which one HDD (HDD#1) is additionally provided in the disk array of RAID0 of FIG. 12 to configure a disk array of RAID0 by two HDDs (HDD#0, HDD#1). The data block groups stored in the disk array of FIG. 12 are relocated in the two HDDs (HDD#0, HDD#1) as shown in FIG. 13 for each stripe unit. In FIG. 13, for example, one stripe S21 is configured by two stripe units 0, 1 of FIG. 12 whose logical block addresses are successive.

Thus, in the capacity expanding process, the data block groups are relocated for each stripe unit.

If a media error does not occur at the read time of the to-be-relocated data block, the to-be-relocated data block is written into the transfer destination position as usual. The transfer destination position is a storage position on the disk array to which a logical block address corresponding to the to-be-relocated data block is newly allocated. On the other hand, if a media error has occurred at the read time of the to-be-relocated data block, the above error data is written into the transfer destination position.

FIG. 14 shows an example of the capacity expanding unit 102.

The capacity expanding unit 102 includes a relocation control unit 201, data read unit 202 and data write unit 203. The relocation control unit 201 determines to-be-relocated data block groups and transfer destination positions of the respective data block groups based on the present redundancy level of the disk array 20 and the number of additional disk drives. The data read unit 202 reads a to-be-relocated data block from the disk array 20 via the disk controller 34 under the control of the relocation control unit 201. The data write unit 203 writes the to-be-relocated data block read by the data read unit 202 into the transfer destination position on the disk array 20 via the disk controller 34 under the control of the relocation control unit 201.

The media error detecting unit 103 detects occurrence of a media error by monitoring success/failure of the read operation via communication with the data read unit 202. When detecting occurrence of the media error, the media error detecting unit 103 inhibits the operation of the data write unit 203 and triggers the error data write unit 104.

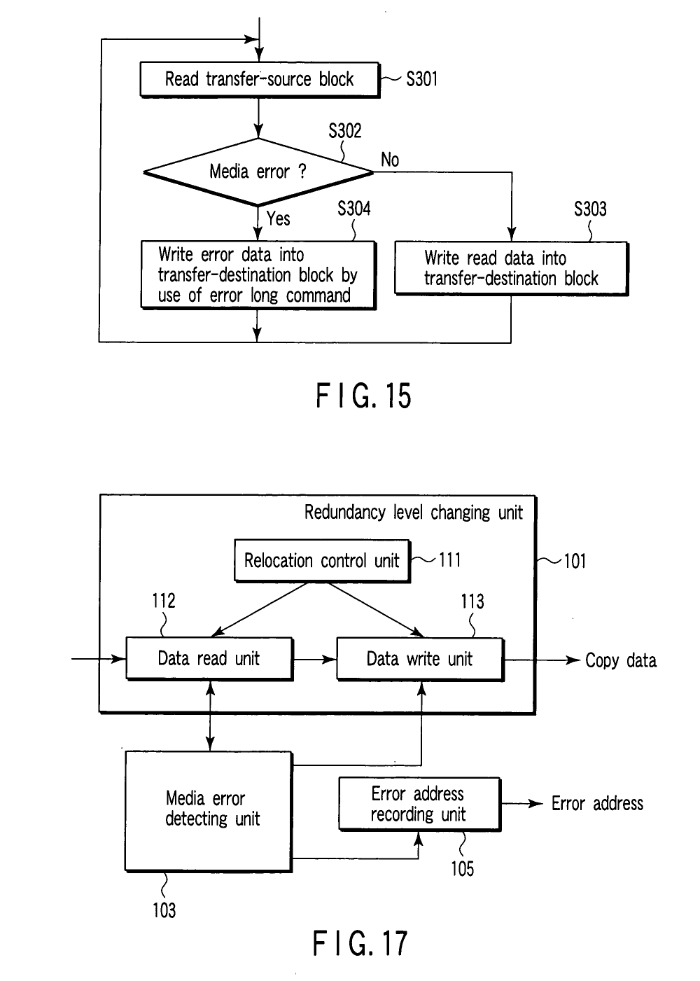

Next, the procedure of the capacity expanding process is explained with reference to the flowchart of FIG. 15.

The capacity expanding unit 102 determines logical block addresses of to-be-relocated data blocks (transfer-source blocks) and transfer destination positions (transfer-destination blocks) corresponding to the logical block addresses based on the present redundancy level of the disk array 20 and the number of additional disk drives. Then, the capacity expanding unit 102 performs a process shown by the flowchart of FIG. 15 for each transfer-source block.

That is, the capacity expanding unit 102 first reads a transfer-source block from the disk array 20 (step S301). If no media error occurs in the read operation (“NO” in step S302), the capacity expanding unit 102 writes the read transfer-source block into a transfer-destination block corresponding to the transfer-source block (step S303). If a media error occurs in the read operation of the step S301 (“YES” in step S302), the error data write unit 104 writes error data into the transfer-destination block by use of a write long command (step S304).

Also, in the capacity expanding process, a transfer-source block in which a media error occurs in the read operation may be used as a transfer-destination block for a different to-be-relocated data block in some cases. In this case, if the different to-be-relocated data block cannot be correctly written into the transfer-destination block, error data is also written into the transfer-destination block.

The data read operation after expanding the capacity of the disk array 20 is performed according to the same procedure as that shown in FIG. 9.

As described above, in each of the redundancy level changing process and capacity expanding process of the present embodiment, if an error such as a media error occurs at the read time of the to-be-relocated data block, error data is written into a transfer-destination block corresponding to the to-be-relocated data block. As a result, even when an error such as a media error occurs during the level changing process and capacity expanding process, the level changing process and capacity expanding process can be continuously performed without interruption.

### Second Embodiment

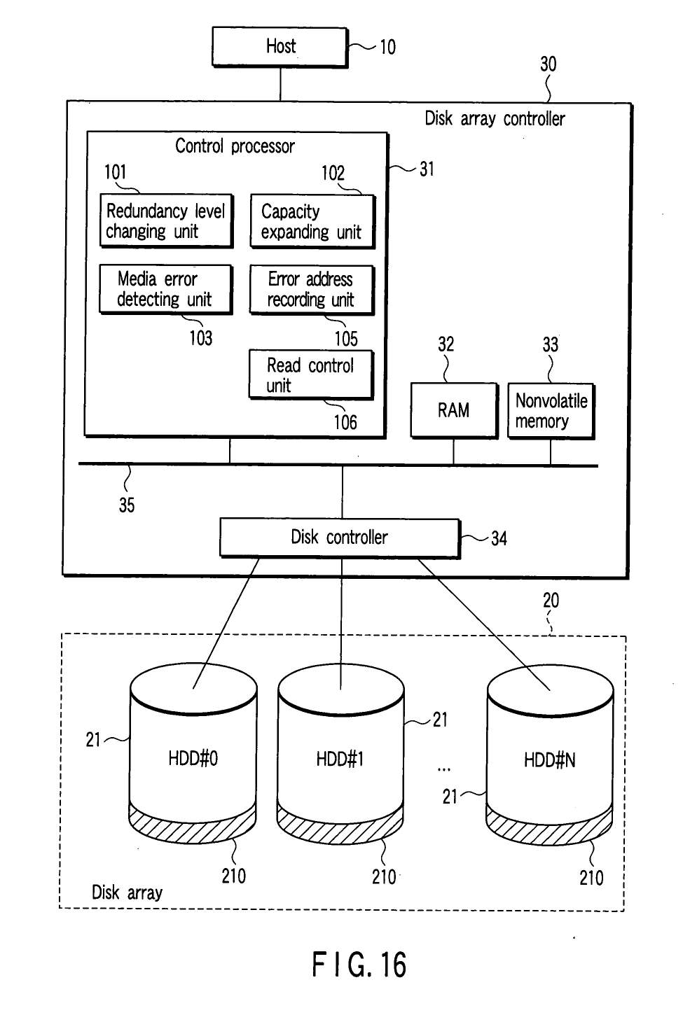

FIG. 16 is a block diagram showing the configuration of an information processing apparatus according to a second embodiment of this invention. In FIG. 16, the same portions as those of FIG. 1 are denoted by the same reference numbers.

In the second embodiment, a control processor 31 of a disk array controller 30 has an error address recording unit 105 and read control unit 106 instead of the error data write unit 104 of FIG. 1. The error address recording unit 105 stores a logical block address LBA which indicates a transfer destination position corresponding to a to-be-relocated data block as an error address into a nonvolatile memory 33 or a reserved region 210 of a disk array 20 when a media error occurs at the read time of the to-be-relocated data block. A logical block address LBA corresponding to each of the to-be-relocated data blocks before the redundancy level changing process or before the capacity expanding process is used as a logical block address LBA of the transfer destination position after the redundancy level changing process or after the capacity expanding process. Therefore, the error address recording unit 105 may store a logical block address of the to-be-relocated data block as an error address when a media error occurs at the read time of the to-be-relocated data block.

After the redundancy level changing process or after the capacity expanding process, the read control unit 106 determines whether or not a logical block address LBA contained in a read access request issued from a file system or application program executed by a host 10 is stored as an error address. If the error address is stored, the read control unit 106 generates a media error.

FIG. 17 shows the relationship between the redundancy level changing unit 101, error address recording unit 105 and media error detecting unit 103. Like the first embodiment, the redundancy level changing unit 101 includes a relocation control unit 111, data read unit 112 and data write unit 113. The media error detecting unit 103 detects occurrence of a media error by monitoring success/failure of the read operation via communication with the data read unit 112. When detecting occurrence of a media error, the media error detecting unit 103 inhibits the operation of the data write unit 113 and triggers the error address recording unit 105. The error address recording unit 105 stores a logical block address corresponding to a to-be-relocated data block in which occurrence of the media error is detected by the media error detecting unit 103 as an error address.

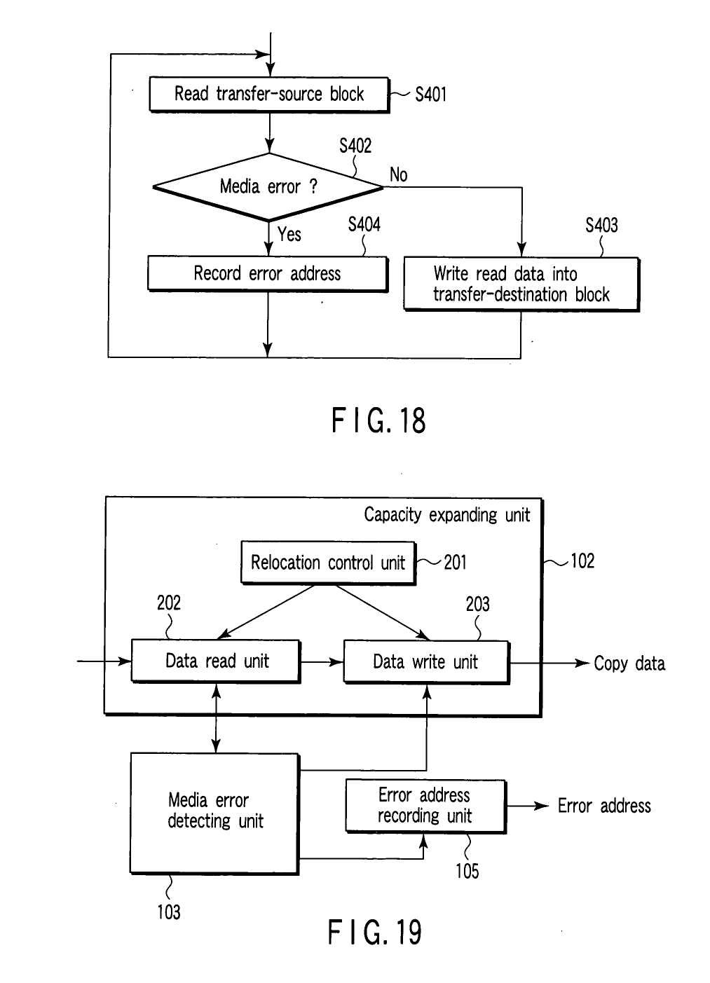

Next, the procedure of the redundancy level changing process is explained with reference to the flowchart of FIG. 18. As described above, the redundancy level changing unit 101 determines logical block addresses of to-be-relocated data blocks (transfer-source blocks) and transfer destination positions (transfer-destination blocks) corresponding to the logical block addresses based on the number of HDDs and the RAID level of the disk array 20 before level-changing, the number of HDDs and the RAID level of the disk array 20 after level-changing specified by the host 10. Then, the redundancy level changing unit 101 performs the process shown by the flowchart of FIG. 18 for each transfer-source block.

That is, the redundancy level changing unit 101 first reads a transfer-source block from the disk array 20 (step S401). If no media error occurs in the read operation (“NO” in step S402), the redundancy level changing unit 101 writes the read transfer-source block into a transfer-destination block corresponding to the transfer-source block (step S403). If a media error occurs in the read operation of the step S401 (“YES” in step S402), the error address recording unit 105 stores a logical block address LBA corresponding to the transfer-source block in which the media error has occurred as an error address (step S404).

As described above, a transfer-source block in which a media error occurs in the read operation for a certain to-be-relocated data block may be used as a transfer-destination block for a different to-be-relocated data block in some cases. In this case, if the different to-be-relocated data block cannot be correctly written into the transfer-destination block, a logical block address LBA to be newly allocated to the transfer-destination block is also stored as an error address.

FIG. 19 shows the relationship between a capacity expanding unit 102, error address recording unit 105 and media error detecting unit 103. Like the first embodiment, the capacity expanding unit 102 includes a relocation control unit 201, data read unit 202 and data write unit 203. The media error detecting unit 103 detects occurrence of a media error by monitoring success/failure of the read operation via communication with the data read unit 202. When detecting occurrence of a media error, the media error detecting unit 103 inhibits the operation of the data write unit 203 and triggers the error address recording unit 105. The error address recording unit 105 stores a logical block address corresponding to a to-be-relocated data block in which occurrence of the media error is detected by the media error detecting unit 103 as an error address.

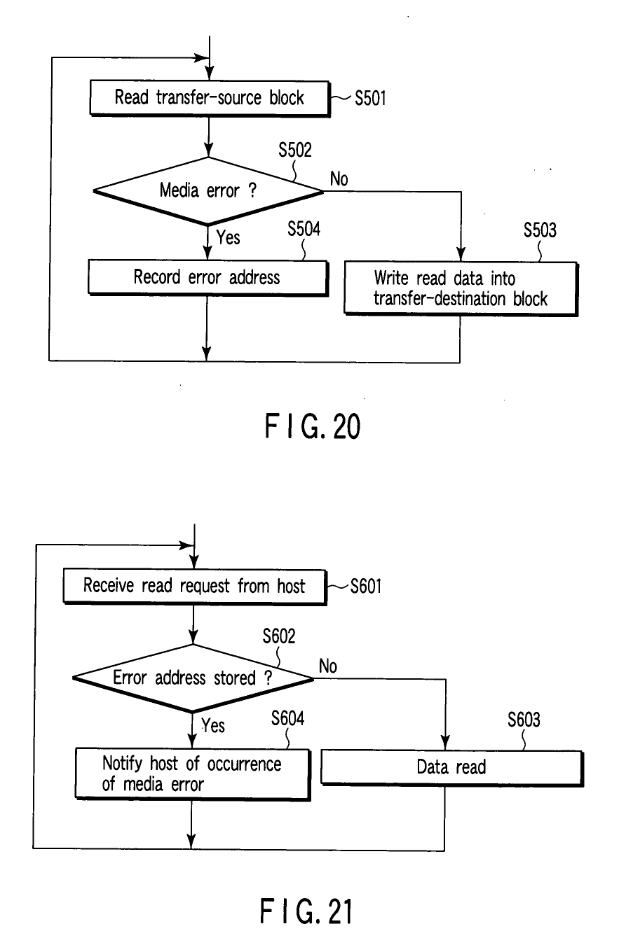

Next, the procedure of the capacity expanding process is explained with reference to the flowchart of FIG. 20.

As described above, the capacity expanding unit 102 determines logical block addresses of to-be-relocated data blocks (transfer-source blocks) and transfer destination positions (transfer-destination blocks) corresponding to the logical block addresses based on the present redundancy level of the disk array 20 and the number of additional disk drives. Then, the capacity expanding unit 102 performs the process shown by the flowchart of FIG. 20 for each transfer-source block.

That is, the capacity expanding unit 102 first reads a transfer-source block from the disk array 20 (step S501). If no media error occurs in the read operation (“NO” in step S502), the capacity expanding unit 102 writes the read transfer-source block into a transfer-destination block corresponding to the transfer-source block (step S503). If a media error occurs in the read operation of the step S501 (“YES” in step S502), the error address recording unit 105 stores a logical block address LBA corresponding to the transfer-source block in which the media error has occurred as an error address (step S504).

As described above, in the capacity expanding process, a transfer-source block in which a media error occurs in the read operation for a certain to-be-relocated data block may be used as a transfer-destination block for a different to-be-relocated data block in some cases. In this case, if the different to-be-relocated data block cannot be correctly written into the transfer-destination block, a logical block address LBA to be newly allocated to the transfer-destination block is also stored as an error address.

Next, the data read operation after changing the RAID level of the disk array 20 or after expanding the capacity is explained with reference to the flowchart of FIG. 21.

When the control processor 31 receives a read access request transmitted from a file system or application program executed by the host 10 (step S601), it causes the read control unit 106 to determine whether or not a logical block address contained in the read access request is stored as an error address (step S602). If the logical block address contained in the read access request is not stored as the error address (“NO” in step S602), the control processor 31 reads a data block specified by the logical block address contained in the read access request from the disk array 20 (step S602). If the logical block address contained in the read access request is stored as the error address (“YES” in step S602), the control processor 31 notifies the host 10 of occurrence of a media error (step S604). Since a media error always occurs when a read request is made with respect to the logical block address stored as an error address, erroneous data can be prevented from being transferred to the host 10. Therefore, in the second embodiment, it is not necessary for each of the HDDs which configure the disk array 20 to support the write long command.

In the so-called software RAID which controls the disk array 20 in a software manner, the redundancy level changing process and capacity expanding process in each of the above embodiments can be performed by use of a RAID control program executed by the host 10.

Further, in each of the above embodiments, the process performed in a case wherein a media error occurs in the to-be-relocated data block is explained, but the process is not limited to a case of occurrence of the media error. For example, when an error such as a read error which prevents the data block from being read from the to-be-relocated data block occurs, the same process can be applied.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A disk array controller which controls a disk array to change a redundancy level of the disk array, comprising:
a read unit which reads a data block to be relocated from the disk array,
a determining unit which determines whether an error has occurred in the to-be-relocated data block read by the read unit,
a write unit which writes the to-be-relocated data block read by the read unit in a relocating destination position on the disk array which corresponds to the to-be-relocated data block when the determining unit determines that the error has not occurred in the to-be-relocated data block, and
an error information setting unit configured to set error information with respect to the relocating destination position if the determining unit determines that the error has occurred in the to-be-relocated data block, the error information causing occurrence of an error in response to read access of the relocating destination position.

2. The disk array controller according to claim 1, wherein the error information setting unit is configured to write data and an error-correcting code which is not associated with the data as the error information in the relocating destination position.

3. The disk array controller according to claim 1, wherein the error information setting unit is configured to store logical address information indicating the relocating destination position as the error information into a nonvolatile storage unit, and to generate an error if logical address information contained in a read access request from a host is stored in the nonvolatile storage unit.

4. A disk array controller which controls a disk array to expand storage capacity of the disk array, comprising:
a read unit which reads a data block to be relocated from the disk array,
a determining unit which determines whether an error has occurred in the to-be-relocated data block read by the read unit,
a write unit which writes the to-be-relocated data block read by the read unit into a relocating destination position on the disk array which corresponds to the to-be-relocated data block if the determining unit determines that the error has not occurred in the to-be-relocated data block, and
an error information setting unit configured to set error information with respect to the relocating destination position if the determining unit determines that the error has occurred in the to-be-relocated data block, the error information causing occurrence of an error in response to read access of the relocating destination position.

5. The disk array controller according to claim 4, wherein the error information setting unit is configured to write data and an error-correcting code which is not associated with the data as the error information in the relocating destination position.

6. The disk array controller according to claim 4, wherein the error information setting unit is configured to store logical address information indicating the relocating destination position as the error information into a nonvolatile storage unit, and to generate an error if logical address information contained in a read access request from a host is stored in the nonvolatile storage unit.

7. An information processing apparatus comprising:
a disk array, and
relocating means for performing a relocating process to relocate a plurality of data blocks stored in the disk array, the relocating means including read means for reading the to-be-relocated data block from the disk array, determining means for determining whether an error has occurred in the to-be-relocated data block read by the read means, write means for writing the to-be-relocated data block read by the read means in a relocating destination position on the disk array which corresponds to the to-be-relocated data block if the determining means determines that an error has not occurred in the to-be-relocated data block, and means for setting error information configured to set error information with respect to the relocating destination position if the determining means determines that the error has occurred in the to-be-relocated data block, the error information causing occurrence of an error in response to read access of the relocating destination position.

8. The information processing apparatus according to claim 7, wherein the means for setting error information includes means for writing data and an error-correcting code which is not associated with the data as the error information in the relocating destination position.

9. The information processing apparatus according to claim 7, wherein the means for setting error information includes means for storing logical address information indicating the relocating destination position as the error information into a nonvolatile storage unit, and means for generating an error if logical address information contained in a read access request from a program is stored in the nonvolatile storage unit.

10. The information processing apparatus according to claim 7, wherein the relocating process is performed to change a redundancy level of the disk array.

11. The information processing apparatus according to claim 7, wherein the relocating process is performed to expand storage capacity of the disk array by using an additional disk drive.
